(19) United States
(12) Patent Application Publication
(10) Pub. No.: US 2010/0147226 A1
(43) Pub. Date: Jun. 17, 2010

(54) Interactive Pet Accessories

(75) Inventor: Steven Tsengas, Fairport Harbor, OH (US)

Correspondence Address: PATENT, COPYRIGHT & TRADEMARK LAW GROUP, 4199 Kinross Lakes Parkway, Suite 275, RICHFIELD, OH, 44286, US

(73) Assignee: OurPet's Company

(21) Appl. No.: 12/334,450

(22) Filed: Dec. 13, 2008

(51) Int. Cl. A01K 15/04; A01K 29/00; A01K 7/02; A01K 1/02; A01K 1/03; A01K 1/10

(52) U.S. Cl. 119/501; 119/163; 119/51.02; 119/720; 119/72; 119/482

(57) ABSTRACT

A coded pet specific proximity sensor incorporates a specific coded sensor or transmitter which is removably worn by or attached to a pet. The sensor limits or encourages access of the pet to certain pet items, such as feeding dishes, pet doors, litter boxes, pet toys, pet beds, etc. These pet items comprises corresponding tags which read when the pet is in proximity of them. The sensors can be preprogrammed to let pets access these items at certain times of day only or they can be individually coded to let only certain pets access them in multiple-pet homes.

### RELATED APPLICATIONS

This application claims a benefit of pending U.S. Ser. No. 12/175,612, filed Jul. 17, 2008, which is a continuation of U.S. Ser. No. 11/708,368, filed on Feb. 20, 2007, which itself claims benefit to U.S. Provisional Application 60/819,906, filed on Jul. 12, 2006. The present application further claims a benefit of pending U.S. Ser. No. 12/110,113, filed on Apr. 25, 2008, which itself claims benefit to U.S. Provisional No. 60/931,679 filed on May 25, 2007. The present invention finally claims priority to subject matter first disclosed in U.S. Provisional 61/012,839, filed Dec. 11, 2007. All the referenced applications are incorporated herein by reference thereto as though they are recited in full.

### BACKGROUND OF THE INVENTION

1. Field of the Invention

The present invention is directed generally to pet accessories and, more particularly, to feeders, shelters, and litter boxes that are programmable for interaction with an identified pet.

2. Description of the Related Art

Approximately 350 million pets—including 93 million cats and 85 million dogs—are members of American families. Many households are homes to multiple pets. As much as these sibling-pets are loved, one oftentimes infringes on and disrupts the tailored needs of another. For example, dogs are keen to investigate cats' waste in litter boxes; they may go as far as experimentally eating it. Dogs try to eat specialized cat foods and visa versa. Dogs having strong allergies, diabetes, obesity, etc. require specialized diets, but their never-ceasing-appetites cause them to at-least try to eat from their sibling dogs' bowls. Oftentimes, a small-sized dog seeks to sprawl across the larger dogs' bed. Basically, sibling-pets don't necessarily recognize what is theirs and what is the others'.

A radio-frequency identification (RFID) tag is already known to set limits to the yard space in which pets can venture. Similar tags are known to prevent pets from visiting couches, carpeted rooms, formal rooms and other off-limit areas in a home. The present invention incorporates corresponding technology within litter boxes, food bowls, and pet toys, etc., so that pets are prevented from investigating, utilizing, or destroying their sibling-pets items.

RFID tags (of transponder devices) are commonly available and utilized to store and remotely retrieving data. An RFID tag is applied to or incorporated into products worn on animals or persons for purposes of identification. Most RFID systems contain at least two parts: an integrated circuit to store and process information, to modulate and demodulate a (RF) signal, and to perform other specialized functions; and, an antenna to receive and transmit the signal. Chipless RFID technology allows for discrete identification of tags without integrated circuits; tags are printed directly onto assets at a lower cost than traditional ones.

RFID tags come in three general varieties: passive; active; and, semi-passive (also known as battery-assisted). Passive tags require no internal power source; they are only active when a nearby-reader powers them. Semi-passive and active tags require a power source, s.a., a small battery or solar power cell.

The present invention incorporates RFID tags to identify a particular pet for interaction with mechanical litter boxes to activate an automatic cleaning cycle and pet food bowls to prevent certain pets from eating from other pets' dishes. It is anticipated that it would be obvious to one skilled in the related art, in light of the present teachings, to extend similar activation to pet toys, pet beds, pet houses, furniture covers or other similar accessories.

### SUMMARY OF THE INVENTION

It is an object of the present invention to make the lives of owners of multiple pets more relaxed by making the owners' “watchful eye” of their pets less demanding.

It is features of the present invention to prevent pets from investigating soiled litters that are not theirs, from dining from pet dishes that are not theirs, and from sleeping on beds that are not theirs.

The present objectives are accomplished by means of an interactive pet article, described below for use in a litter box or a feeding bowl; however, it is anticipated that this remote actuation can take a number of forms. By way of example, and not as a limitation, in a first embodiment, the radio frequency (RF) antenna to receive and transmit the signal transmitter of a passive type is worn by or carried with the pet in order to function as a unique identifier that can be transmitted remotely. In a second embodiment, the radio frequency antenna to receive and transmit the signal transmitter of an active type is worn by or carried with the pet in order to function as a unique identifier that can be transmitted remotely. With such an embodiment a power source would be required, anticipated herein as being of batteries being recharged through a solar recharging means also worn by or carried with the pet. Having an integrated circuit to store and process information, to modulate and demodulate a (RF) signal, and to perform other specialized functions, a self cleaning or self scooping litter box of an otherwise automated design can thereafter be actuated through sensing a cat's position, either after it egresses a litter box so that an automation cleaning cycle can initiate, or upon approaching a litter box such that an articulated cover can be opened to allow access to the litter box. Because the use of an active RFID circuit would result in a continuous power demand, it is anticipated that the integrated circuit would be under power through the use of a AC power supply. However, in an alternate embodiment, such as for use with an automated drinking or feeding bowl, the RFID circuit would be triggered by a secondary proximity sensor, such as IR, optical or mechanical in which the circuit is activated upon the sensing or motion first, with the cycle subsequently accurately responsive to the presence and/or position of a dog or cat wearing a recognizable ID tag. Such a power management solution would allow for such diminished power consumption that the use of batteries would be conveniently manageable.

Consequently, the use of the present invention can be used to accurately sense the presence of a pet relative to a location of an interactive pet device and allow the pet device to thereby react only upon the approach of the properly identified animal.

### BRIEF DESCRIPTION OF THE DRAWINGS

Advantages and features of the present invention are better understood with reference to the following and more detailed description and claims taken in conjunction with accompanying drawings, in which like elements are identified with like symbols, and in which:

FIG. 1 is a perspective view of an interactive, automated pet food or water bowl incorporating the teachings of the present invention;

FIG. 2 is a side elevational view thereof;

FIG. 3 is a schematic representations of a pet specific coded sensor-transmitter apparatus for automation of pet accessories according to alternate preferred embodiment of the present invention.

### DESCRIPTION OF THE PREFERRED EMBODIMENTS

The best mode for carrying out the invention is presented in terms of its preferred embodiment, herein depicted within the Figures.

### 1. Detailed Description of the Figures

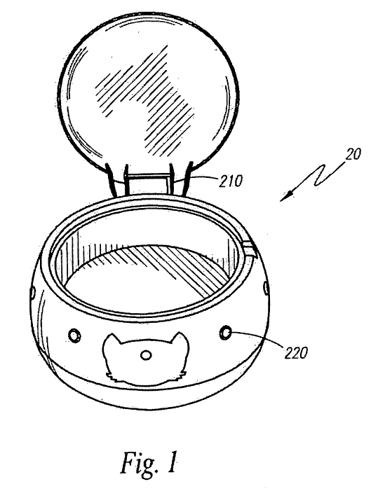

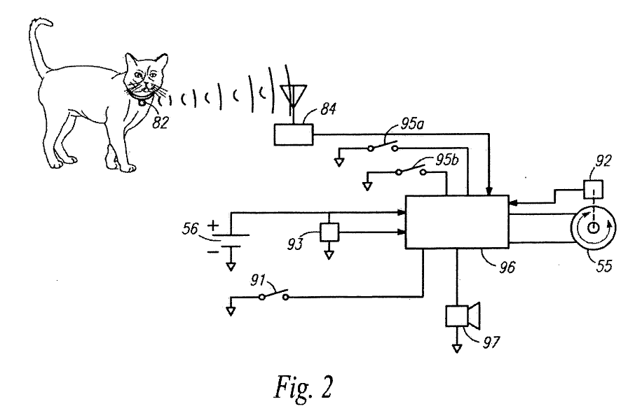

Referring now to FIG. 1-2, an feeding dish or water bowl 20 is made accessible only upon an approach of a pet 22 or a specific pet granted access to it. This feature ensures individualized feeding; it minimizes pets eating from other pets' food. It is also envisioned that such a system can be individualized to accommodate specific feeding schedules in conjunction with a quota, a ration or a diet, so that access to food is generated only upon the presence of the proper pet. The feeding dish comprises an articulating hinged lid 210 operated by means of an electric actuator (not shown). An RFID sensor 220 is included at a sidewall, a base, a lid, or any portion of the bowl 20 where the sensor's range is unobstructed when the lid is in the closed position covering the contents contained therein. The lid 220 opens when the pet having the appropriate ‘learned’ code comes into proximity of the bowl 20. Other pets are prevented from access to the select pet's food.

In order for the RFID sensor to identify a unique animal, a coded pet specific proximity sensor 24 (hereinafter referred to as a “CPSP sensor”) for use with the present invention. The CPSP sensor 24 incorporates a specific coded sensor or receiver 220 which is incorporated into the structure that which access is to be monitored and limited, such as, for example, a bowl, a litter, a door, etc. A corresponding tag with an active, semi-active or passive transmitter 12 is removable worn by or attached to a dog, a cat or another pet 14. The transmitter 12 is carried by or incorporated into a standard collar 16. It can otherwise be attached directly to the pet 14 or to some other article worn by the pet.

Similar to outdoor tags worn in conjunction with invisible fences, the present CPSP sensor 24 is capable of being specifically coded for the individual pet 22. This capability permits various pet objects to be programmed to interact with the pet 22, either generally or uniquely, by their respective sensing of the individual code. The present system includes the structure comprising a sensor and a plurality of various coded tags for multiple pets' collars. The structure device includes a “learn” mode in which the RFID tag is placed in proximity with the corresponding sensor so that the code is recorded into logic.

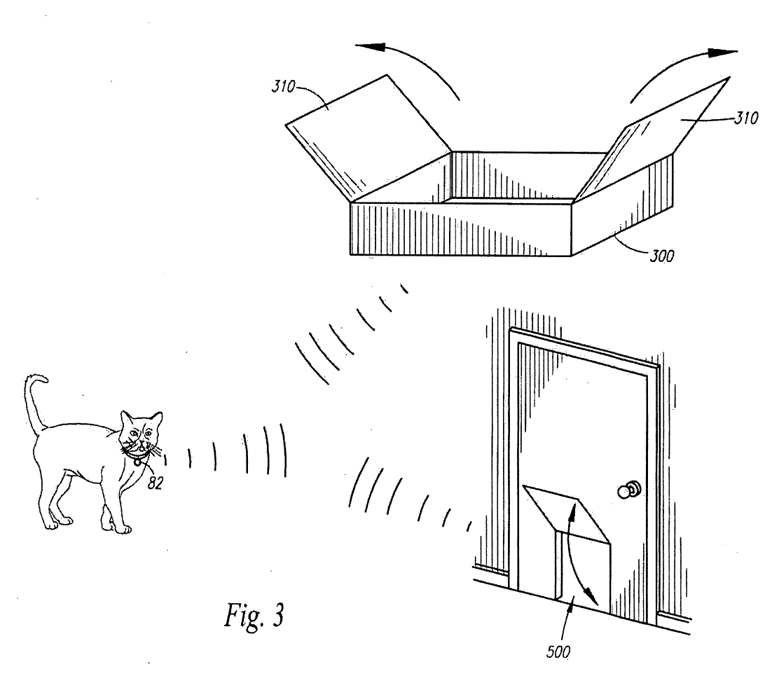

As shown in FIG. 3, other pet devices can be made interactive. The following devices can be coded to work in conjunction with the CPSP sensor 24 of the present invention. These devices are disclosed by way of example, and not as limitations. As shown, a litter box 300 can be adapted having an articulated, hinged cover 310. More specifically, the present invention can be incorporated into the litter box described in U.S. Ser. No. 12/175,612, to the present inventor, the subject matter of which is incorporated herein as if its rewritten in its entirety. A cat or dog litter box 300 is automated to open when it approached by the pet. That box remains closed during other times so other pets are prevented from entry. The litter box may further be automated to actuate a cleaning cycle after the pet egresses it. In this manner, the conventional beam sensor component is not required in a construction of the box. An advantage to litter boxes responsive to coded CPSP sensors is a prevention of coprophagia. It is anticipated that the present CPSP sensor 24 be incorporated with the automated litter box disclosed in U.S. Provisional 61/012,839. Subject matter of the '839 application is incorporated herein as if it is rewritten in its entirety.

Similarly, a pet door 500 can be unlocked and/or opened to grant or to prevent access or egress of pets at certain times preprogrammed by the owner. For example, the CPSP sensor 24 can lock pet doors after dark so that small pets are not attacked by predatory animals in secluded, wooded areas. Oftentimes coyotes are known to prey on smaller pets let out in late evenings. Pet owners are inconvenienced when “watching” their pets be let out or from directing their pets around a home to a lighted front.

Similarly, other uses are anticipated as being adaptable within the teachings of the present invention. A pet house can incorporate a similar pet door 50 to keep out unwanted sibling-pets or to allow access to selected ones.

Also, a pet toy can be made to work in conjunction with the present CPSP sensor 24 to limit or to encourage interactive play of certain toys with their respective pets. More specifically, the present invention can be incorporated into the pet toy described in U.S. Ser. No. 12/110,113, to the present inventor, the subject matter of which is incorporated herein as if its rewritten in its entirety. This system is advantageous in households having smaller and larger breed pets, wherein a smaller pet is prevented from choking on or swallowing smaller toys meant for their smaller sibling-pets.

Sound devices can also includes a speaker or siren positioned within a housing for placement about household furnishings, such as, for example, couches, etc. Detractant sounds, such as sirens, voices, or unpleasant (i.e. high-pitched) noises are thereafter initiated upon an approach of an offending pet; hence, that pet is discouraged from continuing any unwanted habit or behavior.

Referring now to FIG. 4, a schematic block diagram, as shown therein, actuates a motor 55 energized from battery 56 through a pre-programmed micro-processor control 96. Micro control 96 receives input signals from cat sensors 82 and 84. Additional inputs to control 96 may be supplied by a mode select switch 91, a motor stall sensor 92, a battery voltage sensor 93, and a home position sensor 94 for comb 43. Limit switches 95 may be provided for the comb at the storage end 28 of litter box 20 and at the discharge end 29 of the litter box. One or more buzzers or other alarm devices 97 are included in the circuit so that the cat owner can be signaled when the litter box is functional or when other conditions occur, such as an insufficient litter supply in box 20 or a full waste receptacle 68. Circuit components 91-93 and buzzer 97 may all be packaged in the same housing with motor 55. Sensor 94 and limit switches 95 can be incorporated in litter box 20 in appropriate positions as desired.

Additional remote sensing mechanisms can comprise a light sensing circuit, including a photo sensor that senses changes in light levels that occur over short periods of time, such as when a cat approaches the pet toy. Such a functionality can take into consideration the additional “stalking” instinct of predator species like cats.

### 2. Operation of the Preferred Embodiment

In operation, it is assumed that a cat (not illustrated) wearing a radio frequency passive transmitter as a lightweight identification tag enters the proximity of a programmed device. A radio frequency identification (RFID) sensor (synonymous with the present CPSP sensor 24) located on or worn by the animal accurately and repeatably senses the pet's presence in relation to the programmed allowances so that the owner's safety concerns are eliminated

Furthermore, such an apparatus and a method allows for immediate operation of the device, without delay, as soon as the animal approaches or when it is complete utilizing the accessory.

The foregoing descriptions of the specific embodiments are presented for purposes of illustration and description. They are not intended to be exhaustive nor to limit the invention to the precise forms disclosed and, obviously, many modifications and variations are possible in light of the above teaching. By way of example, and not as a limitation, additional stimuli, such as, for example, an initiated-vibration of the pet toy which occurs upon actuation, are also envisioned and should in no way be considered as additional limitations on the present teachings. The embodiments are chosen and described in order to best explain principles of the invention and its practical application, and to thereby enable others skilled in the art to best utilize the invention and its various embodiments with various modifications as are suited to the particular use contemplated. It is intended that a scope of the invention be broadly defined by the Specification and Drawings appended hereto and to their equivalents; hence, the scope of the invention is to be limited only by the following claims.

1. In an improved automated cat litter box having a litter chamber, a motorized comb or rake drive mechanism for removing clumps from said litter chamber, and a means for cycling the drive mechanism, the improvement comprising:
a cat proximity sensor for sensing the relative position of a cat about or within said litter chamber, wherein said cat proximity sensor works in conjunction with a radio frequency device on or worn by the cat.

2. An improved cat litter box according to claim 1, wherein said cat proximity sensor is capable of identifying the location of a cat outside the litter box or litter box or litter chamber.

3. An improved cat litter box according to claim 1, wherein said cat proximity sensor comprises:
a passive or inductive transmitter for identification for modulating and demodulating a radio frequency (RF) signal; and
an antenna for receiving and transmitting a radio frequency (RF) signal.

4. A coded pet specific proximity sensor incorporates a specific coded sensor or transmitter which is removably worn by or attached to a pet, said sensor limits or encourages access of the pet to a feeding dish, said feeding dish comprises a corresponding tag which reads a sensor signal when the pet is in proximity of said dish.

5. A coded pet specific proximity sensor incorporates a specific coded sensor or transmitter which is removably worn by or attached to a pet, said sensor limits or encourages access of the pet to a litter box, said litter box comprises a corresponding tag which reads a sensor signal when the pet is in proximity of said litter box.

6. A coded pet specific proximity sensor incorporates a specific coded sensor or transmitter which is removably worn by or attached to a pet, said sensor limits or encourages access of the pet to a pet door, said pet comprises a corresponding tag which reads a sensor signal when the pet is in proximity of said pet door.

7. A coded pet specific proximity sensor incorporates a specific coded sensor or transmitter which is removably worn by or attached to a pet, said sensor limits or encourages access of the pet to a pet toy, said pet toy comprises a corresponding tag which reads a sensor signal when the pet is in proximity of said pet toy.

8. A system to discriminate between multiple pets' access to monitored structures, said system comprises:
a structure comprising a specific coded radiofrequency sensor;
a plurality of corresponding transmitter tags each for removable carry or attachment on pet collars

9. The system of claim 8, wherein said monitored structures are selected from a group comprising pet feeding bowls, pet drinking bowls, pet doors, litter boxes, and pet houses.

10. The system of claim 8, wherein each of said transmitter tags is capable of being programmed and specifically coded for an individual pet.

11. The system of claim 10, wherein said structure includes a “learn” mode in which a select one of said transmitter tags is placed in proximity with said corresponding sensor so that a code unique for said select one tag is recorded into logic.
